(19) United States
(12) Patent Application Publication
(10) Pub. No.: US 2021/0112642 A1
(43) Pub. Date: Apr. 15, 2021

(54) HIGH CURRENT RGB INTERFACE AND METHOD FOR USE

(71) Applicant: Pacific Insight Electronics Corp., Nelson (CA)

(72) Inventor: Eric D. Sherriff, British Columbia (CA)

(21) Appl. No.: 17/032,591

(22) Filed: Sep. 25, 2020

Related U.S. Application Data
(60) Provisional application No. 62/906,440, filed on Sep. 26, 2019.

(51) Int. Cl. H05B 45/345; H05B 45/20

(52) U.S. Cl. CPC H05B 45/345; H05B 45/48; H05B 45/20

(57) ABSTRACT

An electrical circuit for an illumination device for automotive and other applications is described. The hardware includes a printed circuit board having multiple light emitting diodes (LEDs) each with its own current path; a controller having multiple driver outputs for controlling the LEDs such that the outputs outnumbers the number of LEDs; and a current regulator coupled to one of the controller's driver outputs and to the respective current path of each of the LEDs.

### RELATED APPLICATION

This application claims priority to U.S. Provisional Application No. 62/906,440 filed on Sep. 26, 2019, the entirety of which is incorporated by reference herein.

### BACKGROUND OF THE INVENTION

In RGB light emitting diode (LED) systems, it may be necessary to electrically interface a high power RGB LED (one with individual LED currents up to 200 mA) and a standard RGB controller integrated circuit capable of driving only low power RGB LEDs (having individual LED currents up to 30 mA). Such an interface must provide accurate and temperature stable constant current regulation. It must also allow a controller to control the duty cycles of the individual LEDs so that creation of a wide range of calibrated colors can be achieved by mixing red, green and blue light.

Low current RGB controllers, of the type manufactured by companies such as Melexis and On Semi, may make it possible to drive a high current RGB LED with a low current RGB controller, but such solutions are generally seen as being relatively expensive in the market. Moreover, in certain RGB controllers, the precision constant current LED drive capability is not used, and therefore wasted. Also, a separate 200 mA capable constant current regulator (CCR), one for each color, must be added. Furthermore, the typical RGB controller's low current CCR pins are only used in this type of interface for on/off control over the separate 200 mA capable constant current regulators.

What is needed, therefore, is a less expensive and improved RGB LED interface. Disclosed below is a simpler and less expensive method of controlling a medium or higher power RGB LED display.

### SUMMARY OF THE INVENTION

Disclosed herein are example light emitting diode (LED) circuits. The LED circuit may include, for example, a plurality of LEDs each having a respective current path. In one example, a controller is disclosed for controlling a plurality of LEDs and the controller includes a plurality of driver outputs. In another example, a plurality of controller driver outputs outnumbers the plurality of LEDs. In one aspect of the disclosure, a current regulator coupled to one of the plurality of driver outputs is disclosed. In another feature of the disclosure a current regulator is electrically coupled to a respective current path of each of a plurality of LEDs. In yet another feature of the present disclosure, a current regulator is coupled to one of the plurality of driver outputs through a differential amplifier. In yet another feature of the present disclosure a differential amplifier includes a first differential amplifier transistor and a second differential amplifier transistor.

Disclosed herein are LED circuits in which a base of a first differential amplifier transistor is electrically coupled to one of a plurality of driver outputs. In another feature of the disclosure, a base of a second differential amplifier transistor is electrically coupled to a supply voltage through one or more current sense resistors. In a further aspect of the disclosure, one or more current sense resistors are coupled to a current path of each of a respective current path of LEDs. In yet another aspect of the present disclosure an LED circuit can include a plurality of switches, each of the plurality of switches being respectively associated with each of a plurality of LEDs. In one feature of the present disclosure, each of a plurality of switches are respectively in the current path of a respective plurality of LEDs, and wherein the switch being in an “ON” state allows current to flow through the switch and the respective LED and the switch being in an “OFF” state does not allow current to flow through the switch and the respective LED. In another feature of the disclosure, each of a plurality of switches are field effect transistors, and a plurality of switches are each respectively electrically coupled to a plurality of driver outputs, and a plurality of driver outputs to which the switches are respectively coupled are different than the driver output to which the current regulator is coupled.

Disclosed here are LED circuits in which a controller is adapted to control switches using time division multiplexing. In another aspect of the disclosure, a current regulator includes a current regulator transistor in which a base of the current regulator transistor is coupled to a differential amplifier. In one feature of the disclosure one or more bypass resistors are in parallel with a current regulator transistor. In yet another aspect of the disclosure, a current regulator transistor is adapted pass the current of each of the plurality of LEDs.

Disclosed herein are methods of controlling a light emitting diode (LED) circuit. In one aspect, the methods include providing a plurality of LEDs each having a respective current path. In another aspect of the disclosure the methods may include providing a controller for controlling a plurality of LEDs. In yet another aspect of the disclosure, a controller includes a plurality of driver outputs and the plurality of driver outputs outnumbers the plurality of LEDs. In yet another aspect of the disclosure, disclosed methods include providing a current regulator coupled to one of a plurality of driver outputs through a differential amplifier, the current regulator being electrically coupled to a respective current path of each of a plurality of LEDs. In yet another aspect of the disclosure, the methods include regulating the current passing through the current regulator.

### BRIEF DESCRIPTION OF THE FIGURES

FIG. 1 shows a schematic circuit of a prior-art low current RGB module.

FIG. 2 shows a schematic circuit of a high current RGB module having three separate external 30 mA CCRs are used.

FIG. 3 shows a schematic circuit of an RBG module in accordance with disclosed embodiments.

FIG. 4A shows a circuit diagram for an RGB controller of the type used in the RGB module of FIG. 3 in accordance with disclosed embodiments.

FIG. 4B shows a circuit diagram for an RGB module in accordance with disclosed embodiments.

FIG. 4C shows a circuit diagram for an RGB module in accordance with disclosed embodiments.

FIG. 5, shows a timing diagram for the signal waveforms showing the relationship between the HVIO1, HVIO2, and HVIO3 signals seen in FIG. 4B and the corresponding red, green, and blue LED currents, in accordance with disclosed embodiments.

### DETAILED DESCRIPTION OF THE INVENTION

In one aspect, the outputs from a standard low power controller (available as a standard integrated circuit) is amplified with a single higher current regulator. This regulator output is then switched between the three colored LEDs at rates higher than detectable by human vision, thereby allowing the overall color appearance of the RGB LED array to vary based on the relative on/off times of the individual LEDs.

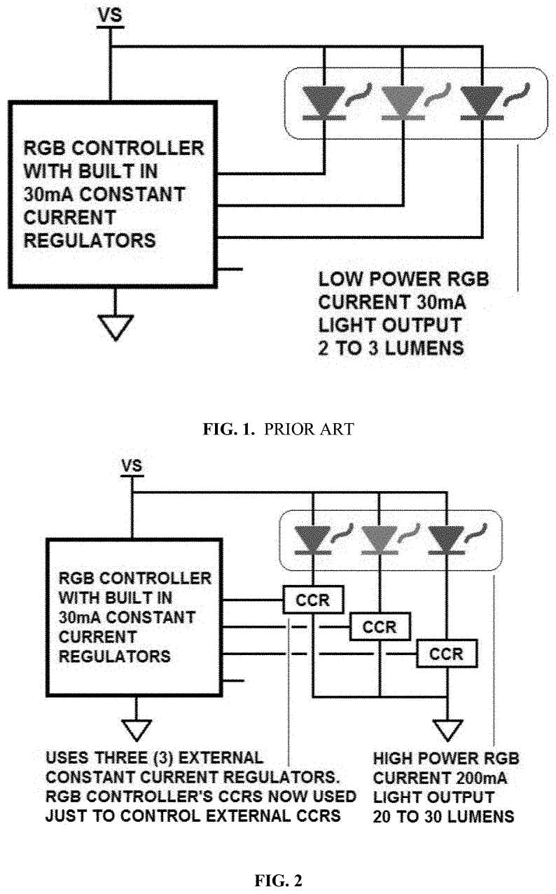

With reference to the figures, in FIG. 1, a type of low current RGB module is shown, in which an RGB controller having a CCR adjustable up to 30 mA is used. In the configuration shown, a light output of about 2-3 lumens is expected from a 20-30 mA current.

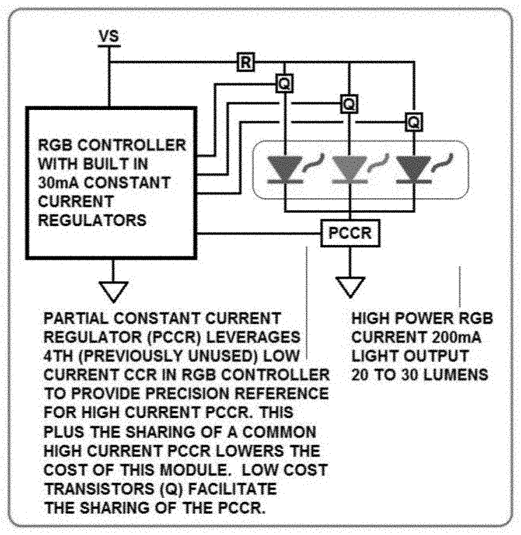

In FIG. 2, a type of high current RGB module is shown, in which an RGB controller having three separate external 30 mA CCRs are used. In the configuration shown, a light output of about 20-30 lumens is expected from a 133-200 mA current.

In FIG. 3, a new RGB module is shown, in which each of the individual external 30 mA CCRs of FIG. 2 now are used to provide on/off control over low cost transistors (Q), and a partial constant current regulatory (PCCR) is used in connection with those transistors. Moreover, the fourth (previously unused) low current CCR of the type shown in FIG. 1 is used to provide precision reference current for the high current PCCR. In this configuration, a light output of about 20-30 lumens is expected from a 133-200 mA current, but at lower unit cost compared to the modules of FIGS. 1 and 2.

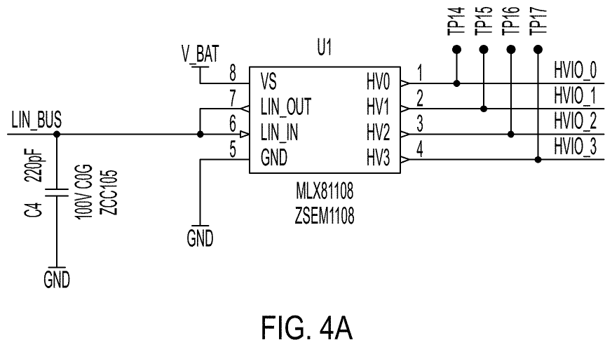

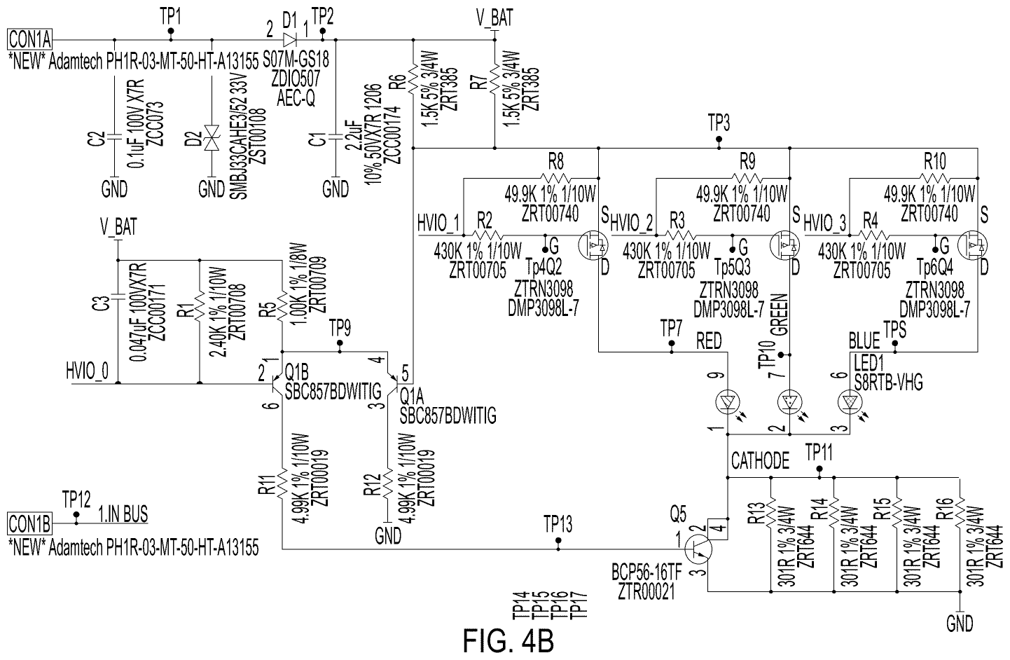

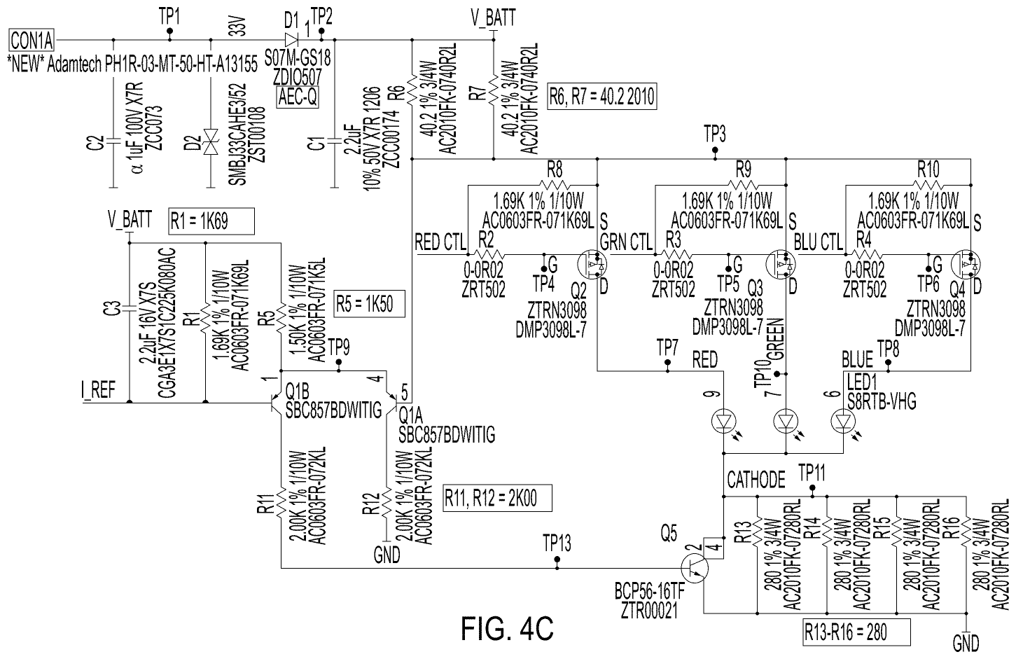

In FIG. 4A, a circuit diagram for a low current RGB controller of the type used in the RGB module of FIG. 3 is shown. With reference to the circuit diagram, high voltage input output (HVIO) LED chip U1 with four drive pins, programmed to sink (conduct to ground) precision currents in 3 mA increments up to 30 mA, is shown. Additionally, the HVIO LED drive pins can be controlled with PWM (Pulse Width Modulation). Integrated capacitor C4 has the attributes as shown.

In FIG. 4B, a circuit diagram for the RGB module of FIG. 3 is shown. With reference to the circuit diagram, reference voltage resistor R1 may be a precision resistor with current sinking into Ul pin 1 (HVIO0), which develops precise voltage across precision resistor Rl. Here, R, with U1 pin 1 current setting, and PWM duty cycle, are set to voltage across Rl at 4V.

Integrated capacitor C3 works with Rl to convert pulsing PWM current being optionally sunk into U1 pin 1 into a steady DC reference voltage. This allows PWM control over the current being sunk into U1 pin 1 which provides for the adjustment of the voltage across R1. Overall, this adjustability can be used to compensate for circuit variance due to component tolerance.

LED Current sense resistors R6, R7 serve to develop a feedback voltage which is fed into the differential amplifier, and these resistors also absorb 4V of excess voltage.

A differential amplifier circuit comprised of differential amplifier transistors QlA, QlB, along with resistors R5, R11 and R12, takes the voltage developed across R1 as the reference voltage and the voltage developed across current sense resistors R6 and R7 other as the current feedback voltage. The feedback and circuit gain drives the voltage difference between the two differential amplifier inputs to close to zero thereby holding the LED current to a constant.

Regulator transistor Q5 is driven by the differential amplifier's output. This device achieves a constant voltage across the sense resistors, which equates to constant current through the LEDs; this transistor is used in the active region and develops considerable power.

Bypass resistors R13 through R16 shunt the regulator transistor Q5, which is driven off at maximum system voltage and is driven on at low voltage. In between these voltage extremes Q5 is in its active region and shares a portion of the LED current with the shunt resistors. The resistors are a less expensive means to dissipate excess voltage, and the operation of Q5 provides the feedback controlled elasticity needed to compensate for system voltages ranging from 9V to 16V.

Transistors Q2 through Q4, along with resistors R2 through R4 and R8 through R10 may be selected from low cost color-select transistors and resistors. These MOSFETs are used as simple ON or OFF switches that steer the current flow to the red, green, or blue LEDs (which are built into one single “RGB” LED). This is so the current regulator output stage (comprised of Q5 (current regulator transistor) in parallel with R13-R16) can be used. With the Q2, Q3 and Q4 arrangement shown, there is no need for three current regulator outputs, one for each of the red, green, and blue LEDs in the RGB. Generally, Q2 through Q4 are not expensive, nor are the resistors R2 through R4 and R8 through R10. The resistors associated with Q2 through Q4 (example R2 and R8 associated with Q2) serve to create source to gate voltages that turn the MOSFET on when the RGB controller sinks current into its HVIOx pin, and turn the MOSFET off when the RGB controller is not sinking current into its HVIOx pin.

In one aspect, the RGB module of FIG. 4B provides an interface in which only one color may be active at a time, in a repeating sequence that operates at over 100 times per second. This is achieved by sharing a single high-power LED PCCR instead of using three high power CCRs to support the red, green, and blue LEDs. It also provides for use of the existing CCR that is built into the RGB controllers, preserving its use but at a reduced cost (i.e., the PCCR cost relative to a full CCR system). The low-cost transistors steer the RGB output onto the single PCCR, which further allows for use of a smaller printed circuit board size due to using one high current PCCR instead of three high current CCRs.

In another aspect, the circuit and LEDS may be fully or partially potted, or the assembly could be potted with multiple layers of different potting compounds that require different solvents for removal.

In FIG. 4C, an alternative circuit diagram for the RGB module of FIG. 3 is shown. As shown, I REF represents the connection to HVIO_0, as shown in FIG. 4A, and “RED CTRL,” “GRN CTRL,” and “BLU CTRL” represent the connections to HVIO_1, HVIO_2, and HVIO_3, respectively, as shown in FIG. 4A. The circuit diagram of FIG. 4C is similar to that of FIG. 4B and the description with respect to FIG. 4B applies to FIG. 4C except where explicitly noted. Similarly, features discussed with reference to FIG. 4C applies to the circuit of FIG. 4B except where explicitly noted. As such, similar component reference numbers are indicated for functionally equivalent components, although certain numerical values are varied.

With reference to the circuit diagrams of FIG. 4A and FIG. 4C, and as discussed above, a low current RGB controller having four sinking pins or connections is provided as U1 by way of example. While this description discusses U1 having four sinking pins for controlling the three different LED channels of a single RGB LED or separate red, green, and blue LEDs, it should be understood that other controllers having greater or fewer pins can also be used so long as the controller contains at least one pin greater than the number of LEDs or LED channels to be controlled. As described herein, the additional sinking pin can be utilized to sink a constant current through resistor R1 into, for example, U1 pin 1 (HVIO0). Because of the constant current sinking capability of even a low cost U1 controller, a precise constant voltage across resistor Rl is developed, which optionally can be varied using the PWM duty cycle capabilities of U1 to compensate for circuit variance. By utilizing the extra current sinking capabilities of U1, the cost associated with developing a separate reference voltage is avoided.

Other drive pins (sinking pins) of U1 (FIG. 4A), e.g., pins 2-4 connected to HVIO_1, HVIO_2, HVIO_3, respectively, may be utilized to control the selection and controlling the on/off of the LED channels, for example red “R,” green “G,” and Blue “B” through lines “RED CTL,” “GRN CTL” and “BLU CTL,” respectively. Transistors Q2 through Q4, which for example are MOSFETS, are used as simple ON or OFF switches that select to which of the LEDs or LED channels within a single “RGB” LED to direct current coming through R6 and R7. The resistors associated with Q2 through Q4 (example R2 and R8 associated with Q2) serve to create source to gate voltages that turn the MOSFET on when the RGB controller U1 sinks current into its respective HVIOx pin, and turn the MOSFET off when the RGB controller U1 is not sinking current into its respective HVIOx pin. In addition, the RED CTR, GRN CTL, and BLU CTL signals may utilize a multiplexing scheme such that each of the LED channels are turned “on” at different times, or such that only one of the channels in on at once. Further, during each “on” signals for each LED channel, the respective signals from controller U1 on RED CTR, GRN CTL, and BLU CTL may be independently controlled via PWM control to vary the resulting apparent brightness of each respective LED channel.

The LED current, which flows through R6, and R7, ultimately flows through transistor Q5 and or bypass resistors R13 through R16 shunt the regulator transistor Q5. By controlling Q5, the current through R6 and R7, and ultimately through the LED channels can be regulated. To accomplish this regulation R6, R7 function to develop a feedback voltage based on the current drawn through the respective LED channels, which is fed into a differential amplifier. The differential amplifier includes transistors QlA, QlB, along with resistors R5, R11 and R12, compared the voltage developed across current sense resistors R6 and R7 (the current feedback voltage) to the voltage developed across R1 (the reference voltage). The feedback and circuit gain of the differential amplifier drives the voltage difference between the two differential amplifier inputs to close to zero by adjusting the output of the differential amplifier to the base of transistor Q5, which regulates the current flow through R6 and R7 until the voltage difference between the two differential amplifier inputs is close to zero. Thus, even as V_Batt varies, which is typical in automotive circuits, the current through the LED channels can be held constant without the temperature effects typical of such transistor circuits.

Why this example describes only maintaining a single LED channel on at a time utilizing time division multiplexing of Q2, Q3, and Q4, there is no requirement that the “on” status of each MOSFET be mutually exclusive. To the contrary, more than one LED channel may be on at the same time. However, as discussed above, the total current through R6 and R7, and all “on” LED channels will be constant regardless of how many LED channels are on. However, as described above, utilizing Q2, Q3, and Q4 for multiplexing establishes a cost-effective solution, in combination with the proportional feedback control of Q5, to provide relatively high power constant current regulation of multiple LED channels.

While the values provided for the circuit diagrams of FIGS. 4B and 4C are exemplary, they are also non-limiting. The disclosure can be utilized for other example currents and component values and the following discussion, with respect to the circuit of FIG. 4C is provided as an example discussion of choosing relative values of the components for the desired applications. Once the desired LED and LED current is selected, for example, the desired LED current (200 mA), the minimum and maximum operating voltages for V_batt or other voltage supply should be considered. Then the minimum supply voltage (VS_min), for example about 9V, the maximum reverse diode voltage (V_diode_max), for example, about 1V and a maximum LED voltage (V_LED_max), for example about 3.9V, are utilized to select sense resistor value(s) (in the example circuit R_sense is R6 in parallel with R7).

At minimum voltages, it can be assumed that Q5 is fully on and there is no voltage drop across main regulator resistor (R13-R16). Thus, R_sense=(VS_min−V_diode_max−V_LED_max)/I_LED, R_sense=(9V−1V−3.9V)/0.2 A=20.5 Ohms (Ω) for R_sense, which is equivalent to two 40.2Ω. R_sense also determines the nominal sense voltage (voltage across R6 and R7) as I_LED*R_sense=0.2V*20.1V=4.02V. The sense voltage also determined the reference voltage on the base of Q1B and the reference resistor value (R1). Using the IC (U1) current sink minimum setting, which may be for example about 3 milliamperes (mA), R1 would be about 4.02V/3 mA=1.34 kiloohms (KΩ). However, to allow some adjustability in the reference voltage to account for component variability, R1 can be selected to be greater, for example about 1.69 KΩ and then the reference current channel can be adjusted with PWM to obtain the desired reference voltage, for example, cycling at 12.5 KHz with an 80% duty cycle. Capacitor C3 working with R1 integrates the PWM into a steady DC voltage. For example, 3 mA*1.69KΩ*0.8=4.05V.

It is also desirable for transistor Q5 to not pass the entirety of the LED current. If Q5 did pass all of the LED current, it would require a higher power (and more expensive) transistor. As such, in one example, to minimize the power dissipated in the regulator, resistors R13, R14, R15, and R16 are included to share the current load of with transistor Q5. To determine the values for the main regulator resistor value R_regulator (e.g., R13-16) the desired LED current (e.g., 200 mA), maximum supply voltage VS_max (e.g., 17V), minimum reverse diode voltage(V_diode_min), minimum LED voltage (V_LED_min) should be considered. In the provided example, assuming at maximum voltage Q5 is fully off and 100% of LED current flows through main regulator resistor R13-R16. Then R_regulator=(VS_max−V_diode_min−V_LED_min−R_sense*I_LED)/I_LED=(17V−0.5V−2.62V−20.1Ω*0.2 A)/0.2 A=49.3Ω. As there are four resistors in parallel, the value of individual resistors is 4*49.3 Ω=197.2Ω; the closest standard 1% value is 196 Ohms. However, depending on the particular cost and availability of the respective components, it may be desirable, for example, to increase the regulator resistor value, e.g., to about 280 Ohms provided Q5 is capable of dissipating additional heat.

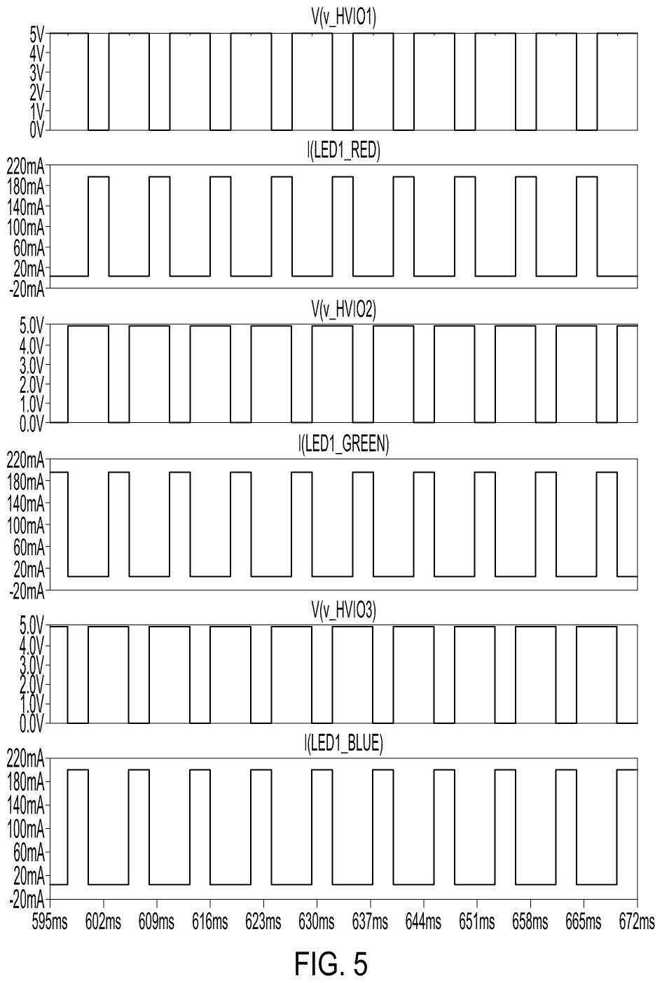

Turning to FIG. 5, shown therein are signal waveforms showing the relationship between the HVIO1, HVIO2, and HVIO3 signals seen in FIG. 4B and the corresponding red, green, and blue LED currents for an example implementation of control signals in which only a single LED channel s is “on” for a particular point in time.

In use, electrical signals, including sensed current, in the above-described circuits may be managed by, for example, embedded software stored in an appropriate memory device on the same printed circuit board as the circuits or on one or more separate but electrically-coupled circuit board. The present circuits may be interfaced with external circuits of, for example, an automotive vehicle electrical system, using one or more suitable electrical connectors, including industry standard pin and socket connectors. The embedded software may include one or more suitable algorithms that may receive signals from the external circuits that represent inputs from a user, such as a vehicle operator, that are intended to alter one or more conditions of the LEDs (for instance, increasing brightness, changing color mix, etc.). The memory device may include specific settings, as input to the software, that establish a state of the circuit and its LEDs when the device in which the circuit is installed is first turned on, turned off, or is in a particular operating condition (e.g., a vehicle operating during nighttime conditions).

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An LED lighting module comprising:
an RGB LED component having a red, a blue, and a green LED, each LED having an output, the outputs of each LED being connected to an associated transistor;
a low power RGB controller for controlling the three LEDs, wherein the controller comprises at least four output leads, three of the output leads being coupled to respective ones of the LED transistors; and
a high power partial constant current regulator coupled to the fourth output lead and further coupled to the combined outputs of the respective three LEDs.

2. The LED module of claim 1, wherein the LED lighting module is adapted to sequentially color mix light from each of the three LEDs.

3. The LED module of claim 1, further comprising a printed circuit board, wherein the three LEDs are potted on the printed circuit board in a single layer.

4. A light emitting diode (LED) circuit comprising:
a plurality of LEDs each having a respective current path;
a controller for controlling the plurality of LEDs, wherein the controller comprises a plurality of driver outputs, wherein the plurality of driver outputs outnumbers the plurality of LEDs, and
a current regulator coupled to one of the plurality of driver outputs, the current regulator electrically coupled to the respective current path of each of the plurality of LEDs.

5. The LED circuit of claim 4, wherein the current regulator is coupled to one of the plurality of driver outputs through a differential amplifier.

6. The LED circuit of claim 5, wherein the differential amplifier comprises a first differential amplifier transistor and a second differential amplifier transistor.

7. The LED circuit of claim 6, wherein a base of the first differential amplifier transistor is electrically coupled to the one of the plurality of driver outputs.

8. The LED circuit of claim 6, wherein a base of the second differential amplifier transistor is electrically coupled to a supply voltage through one or more current sense resistors.

9. The LED circuit of claim 8, wherein the one or more current sense resistors are coupled to the current path of each of the respective current paths of the LEDs.

10. The LED circuit of claim 4, further comprising a plurality of switches, each of the plurality of switches being respectively associated with each of the plurality of LEDs.

11. The LED circuit of claim 10, wherein each of the plurality of switches being respectively in the current path of the respective plurality of LEDs, and wherein the switch being in an “ON” state allows current to flow through the switch and the respective LED and the switch being in an “OFF” state does not allow current to flow through the switch and the respective LED.

12. The LED circuit of claim 11, wherein each of the plurality of switches are field effect transistors, and the plurality of switches are each respectively electrically coupled to the plurality of driver outputs, and the plurality of driver outputs to which the switches are respectively coupled are different than the one of the plurality of driver outputs to which the current regulator is coupled.

13. The LED circuit of claim 12, wherein the controller is adapted to control the switches using time division multiplexing.

14. The LED circuit of claim 4, wherein the current regulator comprises a current regulator transistor, wherein a base of the current regulator transistor is coupled to a differential amplifier.

15. The LED circuit of claim 14, further comprising one or more bypass resistors in parallel with the current regulator transistor.

16. The LED circuit of claim 14, wherein the current regulator transistor is adapted pass the current of each of the plurality of LEDs.

17. A method of controlling a light emitting diode (LED) circuit comprising:
providing a plurality of LEDs each having a respective current path;
providing a controller for controlling the plurality of LEDs, wherein the controller comprises a plurality of driver outputs, wherein the plurality of driver outputs outnumbers the plurality of LEDs, and
providing a current regulator coupled to one of the plurality of driver outputs through a differential amplifier, the current regulator being electrically coupled to the respective current path of each of the plurality of LEDs;
regulating the current passing through the current regulator.
